(19) United States
(12) Patent Application Publication
(10) Pub. No.: US 2014/0304700 A1
(43) Pub. Date: Oct. 9, 2014

(54) METHOD AND APPARATUS FOR UPDATING APPLICATION IN ELECTRONIC DEVICE

(71) Applicant: Samsung Electronics Co., Ltd., Gyeonggi-do (KR)

(72) Inventors: Jin-Hyoung Kim, Seoul (KR); Kang-Jin Yoon, Seoul (KR); Yong-Seok Park, Seoul (KR); Bo-Hyun Kang, Seoul (KR); Han-Il Yu, Gyeonggi-do (KR); Chang-Yeong Kim, Seoul (KR)

(73) Assignee: Samsung Electronics Co., Ltd., Gyeonggi-do (KR)

(21) Appl. No.: 14/249,200

(22) Filed: Apr. 9, 2014

(30) Foreign Application Priority Data
Apr. 9, 2013 (KR) 10-2013-0038678

(51) Int. Cl. G06F 9/445

(52) U.S. Cl. CPC G06F 8/65
USPC 717/173; 717/168

(57) ABSTRACT

A method and apparatus provide for updating an application in an electronic device. The method includes intercepting an update notification for informing that it is necessary to update the application. The method also includes determining whether an update condition based on an update policy is satisfied or not. The method also includes, when the update condition is not satisfied, delaying transmitting the update notification until a next time to determine.

### PRIORITY

The present application is related to and claims priority under 35 U.S.C. §119 to an application filed in the Korean Intellectual Property Office on Apr. 9, 2013 and assigned Serial No. 10-2013-0038678, the contents of which are incorporated herein by reference.

### TECHNICAL FIELD

The present disclosure relates to updating an application installed in an electronic device.

### BACKGROUND

In the embodiment of the electronic devices that have been widely distributed in recent years like smart phones, users may install various kinds of applications. In general, an application store is provided for the user to easily install the application in the electronic device, and a separate market place application is provided to access the application store. Accordingly, the electronic device can access a plurality of application stores and a plurality of market place applications for each of the application stores may be installed in the electronic device.

When a developer or provider of an application that has been installed in the electronic device releases an improved version of the application, the application may be wirelessly updated in the electronic device. The application update may be selectively performed by a user's direct instruction or may be automatically updated according to setting. In the embodiment of the automatic application update, when the developer or provider uploads the improved version of the application to a server, the server transmits a push notification for informing that the application could be updated to the market place application installed in the electronic device, and the market place application accesses the server and updates the application. In the embodiment of the manual application update, when the developer or provider uploads the improved version of the application to the server, the server transmits the push notification for informing that the application could be updated to the market place application of the electronic device, and the user determines whether to update the application or not. When the user determines to update the application, the market place application accesses the server and updates the application. Alternatively, the application may directly receive the push notification from the server without passing through a separate management application, and then may access the server and may be updated.

The user may install a plurality of applications for the sake of convenient use of the electronic device. As the number of applications installed in the electronic device increases, the number of times the applications are updated increases. It is common that the application update uses a large amount of wireless traffic to be transmitted and received. Accordingly, the electronic device consumes much battery power to transmit and receive data. Since the electronic device is operated by the power supplied from the battery for a long time, how long the electronic device can be operated using the battery is a main performance indicator of the electronic device. Therefore, there is a need for a method for increasing the battery life of the electronic device by minimizing battery consumption for the application update.

### SUMMARY

To address the above-discussed deficiencies, it is a primary object to provide a method and apparatus for reducing battery consumption caused by an application update in an electronic device.

Another aspect of the present disclosure is to provide a method and apparatus for performing an application update in an electronic device considering a state of the electronic device.

Another aspect of the present disclosure is to provide a method and apparatus for performing an application update in an electronic device only when a pre-defined condition is satisfied.

Another aspect of the present disclosure is to provide a method and apparatus for delaying transmitting a push notification for informing of an application update in an electronic device.

According to an aspect of the present disclosure, a method for updating an application installed in an electronic device includes: intercepting an update notification for informing that it is necessary to update the application; determining whether an update condition based on an update policy is satisfied or not; and, when the update condition is not satisfied, delaying transmitting the update notification until a next time to determine.

According to another aspect of the present disclosure, an apparatus for updating an application installed in an electronic device includes: a memory for storing an update policy for controlling a time to update the application; and a processor for intercepting an update notification for informing that it is necessary to update the application, determining whether an update condition based on the update policy is satisfied or not; and, when the update condition is not satisfied, delaying transmitting the update notification until a next time to determine.

According to another aspect of the present disclosure, an electronic apparatus includes: a memory for storing at least one software module; and a processor for executing the at least one software module stored in the memory, wherein the at least one software module intercepts an update notification for informing that it is necessary to update the application, determines whether an update condition based on an update policy is satisfied or not; and, when the update condition is not satisfied, delays transmitting the update notification until a next time to determine.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It could be noted that the functionality associated with any particular controller may be centralized or distributed, whether locally or remotely. Definitions for certain words and phrases are provided throughout this patent document, those of ordinary skill in the art could understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a view showing block configurations of an electronic device and a server which provides an application according to an example embodiment of the present disclosure;

FIG. 2 illustrates a view showing a block configuration of an update controller of an electronic device according to an example embodiment of the present disclosure;

FIGS. 3A to 3C illustrate views showing examples of user interfaces (UIs) for setting an update policy in an electronic device according to an example embodiment of the present disclosure;

FIG. 4 illustrates a view showing a relationship between market place applications and push clients on one hand, and an update controller on the other in an electronic device according to an example embodiment of the present disclosure;

FIG. 5 illustrates a view showing block configurations of an electronic device and a server which provides an application according to another example embodiment of the present disclosure;

FIG. 6 illustrates a view showing an example of a UI for setting an update policy in an electronic device according to an example embodiment of the present disclosure;

FIG. 7 illustrates a view showing block configurations of an electronic device and a server which provides an application according to another example embodiment of the present disclosure;

FIG. 8 illustrates a view showing a block configuration of an update controller of a server according to another example embodiment of the present disclosure;

FIG. 9 illustrates a view illustrating a block configuration of an update control agent of an electronic device according to another example embodiment of the present disclosure;

FIG. 10 illustrates a process of an operation procedure of an update controller which is included in an electronic device or a server according to an example embodiment of the present disclosure;

FIG. 11 illustrates a process of an operation procedure of an update control agent which is included in an electronic device according to an example embodiment of the present disclosure;

FIG. 12 illustrates a process of a block configuration of an electronic device according to an example embodiment of the present disclosure; and

FIG. 13 illustrates a process of a block configuration of a server according to an example embodiment of the present disclosure.

### DETAILED DESCRIPTION

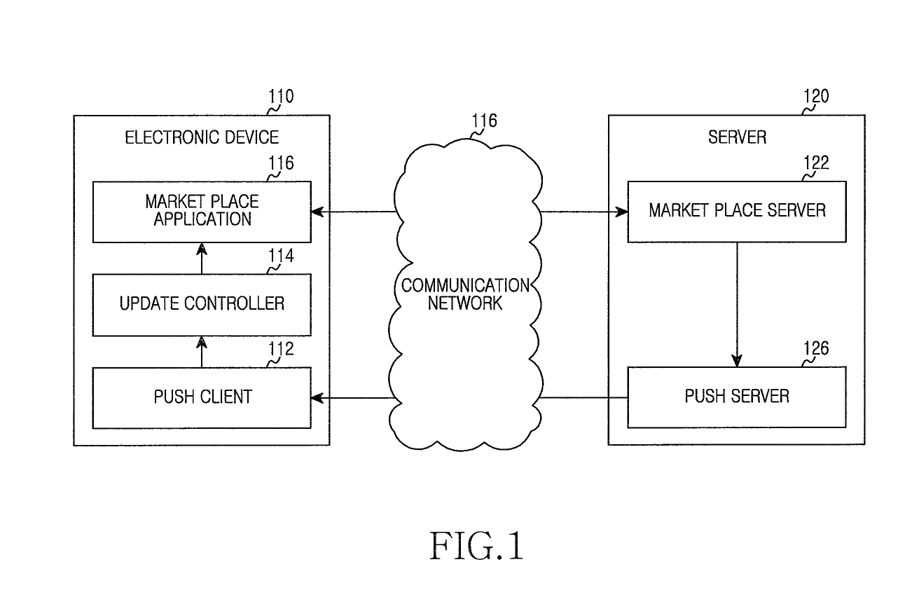

FIGS. 1 through 13, discussed below, and the various embodiments used to describe the principles of the present disclosure in this patent document are by way of illustration only and could not be construed in any way to limit the scope of the disclosure. Those skilled in the art will understand that the principles of the present disclosure may be implemented in any suitably arranged system or method. Example embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein could be understood based on the descriptions made herein.

The present disclosure provides a method and apparatus for reducing battery consumption caused by an application update in an electronic device.

The electronic device may be a portable electronic device, and may be one of a smart phone, a portable terminal, a mobile phone, a mobile pad, a media player, a tablet computer, a handheld computer, and a Personal Digital Assistant (PDA). In addition, the electronic device may be any device that combines two or more functions of the above-mentioned devices.

It is common that data for the application update has a great size, but is traffic that is not urgent, that is, delay-tolerant traffic. Accordingly, the present disclosure proposes a technique for extending a battery life of the electronic device by providing a function of intelligently controlling the application update without affecting a user experience (UX) when an application is updated in the electronic device.

Furthermore, the present disclosure proposes a priority-based updating technique, which updates an application regardless of battery consumption when the application is frequently used by the user, the update is set to be controlled according to a priority of the application, or the update could be performed for the sake of security, even if the electronic device is operated by the battery.

In addition, the present disclosure proposes a method for efficiently reducing battery consumption in the entire electronic device by providing an intelligent application update control function in a platform of the electronic device.

The application update control function described above may be included in the electronic device used by the user, may be included in a server which provides an application, or may be included in both of the electronic device and the server.

If the application update control function is included in the electronic device, the electronic device and the server are configured as shown in FIG. 1. FIG. 1 illustrates a view showing block configurations of an electronic device and a server which provides an application according to an example embodiment of the present disclosure.

Referring to FIG. 1, the electronic device 100 and the server 120 exchange data with each other through a communication network 130. The communication network 130 may be a 3^{rd} Generation (3G) network, a Long Term Evolution (LTE) network, Wireless Fidelity (Wi-Fi), and the like. The electronic device 100 includes a push client 112, an update controller 114, and a market place application 116. The server 120 includes a market place server 122 and a push server 126.

The market place server 122 stores and manages applications to be provided to the electronic device 110. In addition, if there is a request for an application, the market place server 122 transmits the requested application to the electronic device through the communication network 130. The push server 126 transmits an update notification for informing of an update to the electronic device 110 where the application registered at the market place server 122 is installed. For example, if an improved version of the application that has been registered at the market place server 122 is newly registered, the push server 126 transmits the update notification to at least one electronic device where the application is installed, through the communication network 130.

The push client 112 receives the update notification transmitted from the push server 126. The push client 112 provides the update notification to the update controller 114. However, according to a detailed example embodiment, the push client 112 may recognize the update notification as being transmitted to the market place application 116. That is, the update controller 114 may intercept the update notification which is transmitted from the push client 112 to the market place application 116.

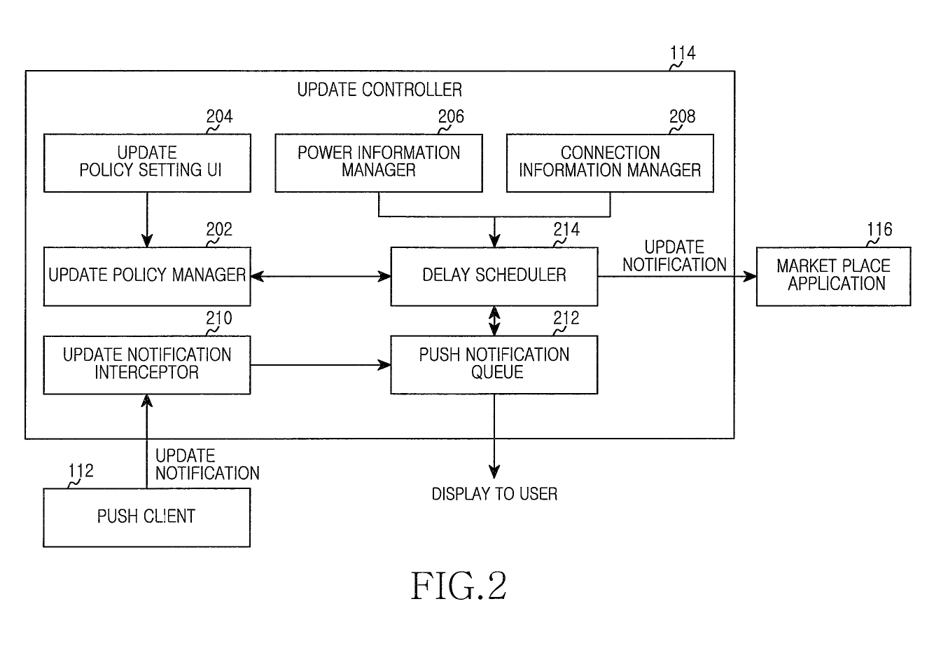

The update controller 114 identifies the update notification output from the push client 112 and intercepts the update notification to prevent it from being transmitted to the market place application 116. That is, the update controller 114 delays transmitting the update notification. If a pre-defined condition is satisfied, the update controller 114 transmits the update notification to the market place application 116. In an embodiment, the update controller 114 controls time to update by controlling the update notification, which is transmitted to the market place application 116 for the application update, based on at least one of a priority of a push notification, a priority of the application, a power state of the electronic device 110, and a connection state of the electronic device. Hereinafter, the detailed configuration and operation of the update controller 114 will be explained with reference to FIG. 2.

The market place application 116 receives the update notification and updates the pre-installed application which is identified by the update notification. To achieve this, the market place application 116 requests the improved version of the application from the market place server 122 through the communication network 130, and updates the application by installing the improved version of the application. In this embodiment, according to an example embodiment of the present disclosure, the market place application 116 may update the application swiftly by receiving data for updating the application using multiple connections established through a plurality of communication networks (for example, LTE and Wi-Fi) simultaneously.

FIG. 2 illustrates a view showing a block configuration of an update controller of an electronic device according to an example embodiment of the present disclosure.

Referring to FIG. 2, the update controller 114 includes an update policy manager 202, an update policy setting UI 204, a power information manager 206, a connection information manager 208, an update notification interceptor 210, a push notification queue 212, and a delay scheduler 214.

The update policy manager 202 manages update policy-related information which is input through the update policy setting UI 204. The update policy-related information includes an update policy and basic information for determining whether a condition based on the update policy is satisfied or not. The update policy is a set of conditions for determining whether to perform the update or not, and the basic information refers to a state of an evaluation target of the condition. For example, the basic information may include at least one of an application priority, a power state, and a connection state. In addition, the update policy defines at least one of a priority range of the application to allow the update, a type of power to allow the update (for example, Alternating Current (AC) charging, Universal Serial Bus (USB) charging, or a battery), a battery level to allow the update, a type of connection to allow the update, and a signal quality of connection to allow the update. The application priority refers to a priority of an application to be updated. For example, an application that is frequently used by the user is given a high priority. For another example, the priority of the application may be directly set by the user. The power state may be divided into information on whether the electronic device uses a battery or not, a battery level when the battery is used, AC charging, and USB charging. The connection state refers to a type of connection accessed by the electronic device (for example, Wi-Fi, 3G, LTE, and the like), or a strength of signal.

The update policy setting UI 204 provides a UI for the user to set the update policy, and transmits information input by the user to the update policy manager 202.

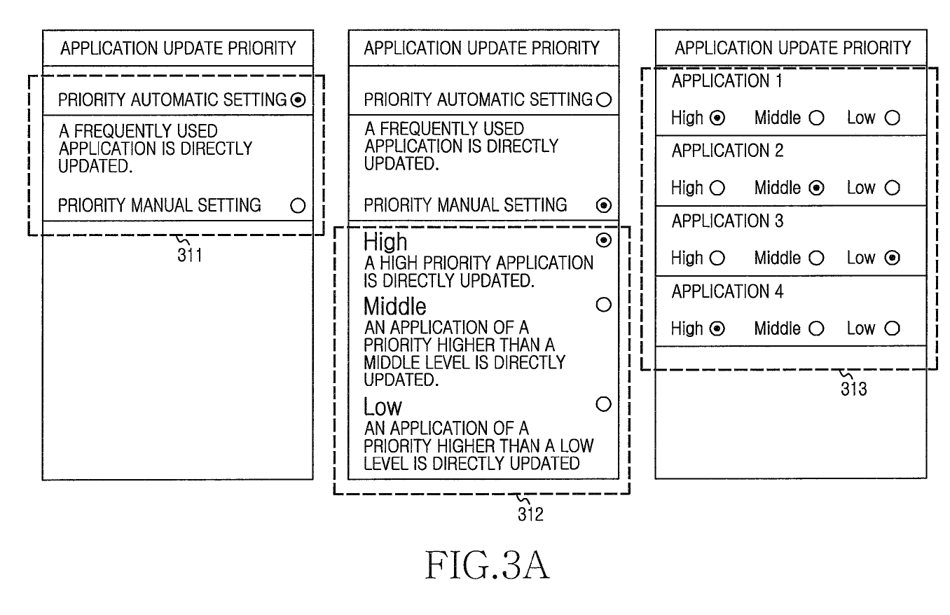

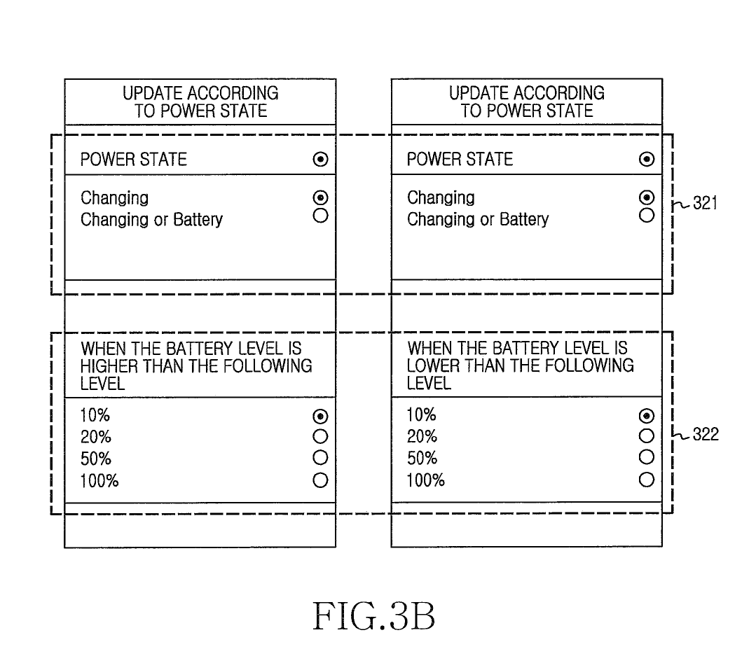

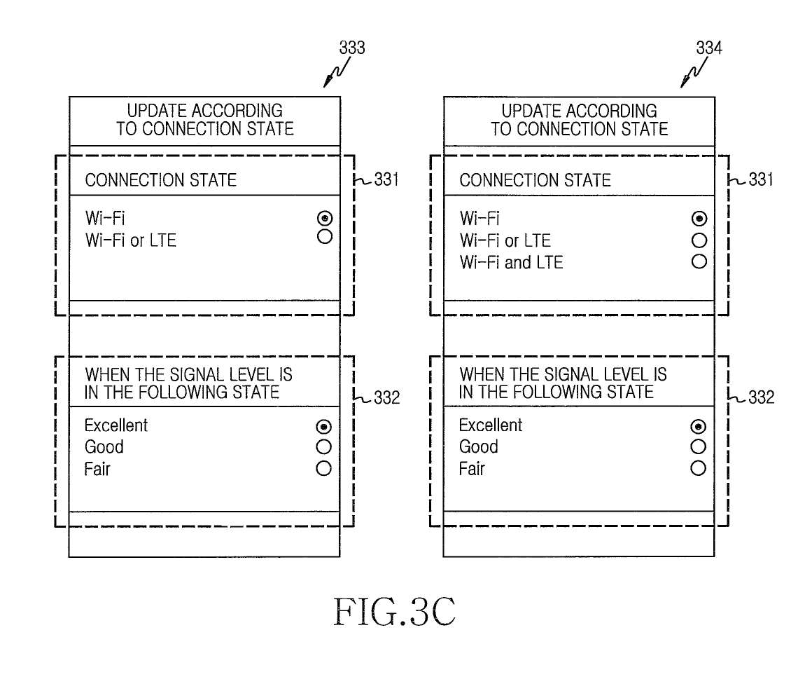

For example, the update policy setting UI 204 may provide a UI for setting the update policy based on the priority of the application. For example, as show in FIG. 3A, the UI may include an item 311 for selecting whether the priority is automatically set or not, an item 312 for directly setting whether to update or not according to the priority when the priority automatic setting is not selected, and an item 313 for designating a priority for each application. Through the UI, the user may set the method of determining the priority of the application to be one of the automatic setting and the manual setting. When the priority automatic setting is selected, the priority of the application is determined according to pre-defined regulations. For example, the frequently used application may be given a high priority to be directly updated. When the priority manual setting is selected, the priority of the application is determined by user's designation. In an embodiment, when the priority manual setting is selected and “High” is selected, the application that is given a high priority may be updated regardless of the other conditions. The application that is given a middle or low priority may be updated when the other conditions are satisfied.

For another example, the update policy setting UI 204 may provide a UI for setting the update policy based on the power state. For example, as shown in FIG. 3B, the UI may include an item 321 for designating a type of power to allow the update, and an item 322 for designating a battery level to allow or prohibit the update. In the example of FIG. 3B, the UI does not distinguish types of charging, but, according to another example embodiment of the present disclosure, the UI may distinguish types of charging (for example, AC charging or USB charging), thereby providing more detailed setting. Through the UI, the user may set to allow the update if the battery level is greater than or equal to a threshold value or may set to prohibit the update if the battery level is less than the threshold value. In addition, the user may set to allow the update only if charging is performed by an external power source like AC charging or USB charging.

For another example, the update policy setting UI 204 may provide a UI for setting the update policy based on the connection state. For example, as shown in FIG. 3C, the UI may include an item 331 for designating a type of connection to allow the update, and an item 332 for designating a signal quality to allow the update. In view 333 of FIG. 3C, the type of connection is divided into two types, ‘Wi-Fi’ and ‘Wi-Fi or LTE’. However, according to another example embodiment of the present disclosure, the UI may provide more detailed setting for designating whether to update or not for all types of connection that can be supported by the electronic device 110. The UI shown in view 334 of FIG. 3C further includes an option ‘Wi-Fi and LTE’ in comparison to the UI shown in view 333 of FIG. 3C. The option ‘Wi-Fi and LTE’ is a state in which the electronic device is connected to Wi-Fi and LTE simultaneously, and is to allow the market place application to access the market place server through both of the Wi-Fi and the LTE and thus update the application swiftly. Through the UT, the user may set to update only when a specific type of connection is established and only when signals have a specific signal quality.

The power information manager 206 collects battery state information of the electronic device and information on whether an AC/USB is connected or not, and provides the information. If the power state of the electronic device is changed, the power information manager 206 informs the delay scheduler 214 of the change of the power state. The power information includes the battery level, information on whether the AC charging is connected or not, and information on whether the USB is connected or not.

The connection information manager 208 collects information on the connection accessed by the electronic device (for example, Wi-Fi, 3G, LTE, and the like) and provides the information Furthermore, the connection information manager 208 may provide Internet connectivity for each connection or a Received Signal Strength Indicator (RSSI). If the connection state of the electronic device is changed, the connection information manager 208 informs the delay scheduler 214 of the change of the connection state.

The update notification interceptor 210 may receive the update notification output from the push client 112 on behalf of the market place application 116 or may intercept the update notification which is transmitted to the market place application 116. In other words, the update notification interceptor 210 intercepts the update notification if the push client 112 transmits the update notification to the market place application 116, and stores the update notification in the push notification queue 212. To this end, the update notification received by the update notification interceptor 210 is not transmitted to the market place application 116, which is an original destination. The update notification interceptor 210 may intercept the update notification in the following methods. According to an example embodiment of the present disclosure, the update notification interceptor 210 may hook the update notification in a network layer including an Internet Protocol (IP). To achieve this, the update notification interceptor 210 could identify the update notification. For example, the update notification interceptor 210 may identify the update notification using a specific bit pattern of an IP packet. According to another example embodiment of the present disclosure, the update notification interceptor 210 may hook the update notification in an Operating System (OS) or an application framework of the electronic device or server. According to another example embodiment of the present disclosure, the update notification interceptor 210 may allow the push client 112 to explicitly transmit the update notification using a separate Application Program Interface (API) installed in the update controller 114.

The push notification queue 212 temporarily stores the update notification obtained through the update notification interceptor 210. If a new update notification is stored in the push notification queue 212, the push notification queue 212 may inform the user of existence of the new update through an outputting means. The operation of informing of the existence of the new update may be performed by the delay scheduler 214. For example, the existence of the new update may be notified by displaying a corresponding icon on an upper notice bar of the electronic device. In this embodiment, if the user determines to proceed with the update (for example, by clicking an icon), the update may be directly performed regardless of the update policy. However, if the update could be delayed according to the update policy, the delay of the update may be notified to the user.

The delay scheduler 214 controls time to transmit the update notification to the market place application 116 based on the priority of the application, the power information, the connection information, and the like. In an embodiment, the delay scheduler 214 determines whether a condition for transmitting the update notification is satisfied or not based on the priority of the application, the power information, the connection information, and the like, and, if the condition is satisfied, transmits the update notification to the market place application 116.

To achieve this, the delay scheduler 214 periodically receives the power information and the connection information of the electronic device from the power information manager 206 and the connection information manager 208. In this embodiment, the delay scheduler 214 periodically determines whether to update or not according to the update policy set by the update policy manager 202, and transmits the update notification to the market place application 116. For another example, the delay scheduler 214 may receive the power information and the connection information of the electronic device only if the information is changed. In this embodiment, the delay scheduler 214 examines the push notification queue 212 when receiving an information change event, and, when there is an update notification stored in the push notification queue 212, transmits the update notification to the market place application 116 according to the update policy set by the update policy manager 202.

However, if the user determines to proceed with the update (for example, by clicking an icon), the update may be directly performed regardless of the update policy. In other words, if the user requests a prompt update, the update may be performed regardless of the update policy. That is, if the update is performed by user's selection, the delay scheduler 214 disregards the update policy and transmits the update notification to the market place application 116.

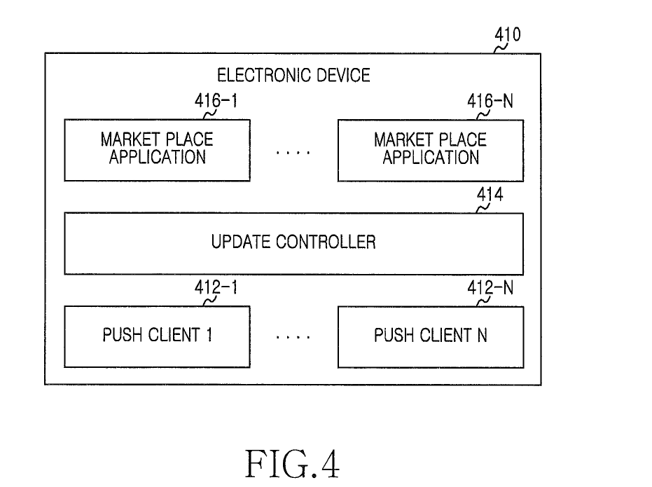

FIG. 4 illustrates a view showing a relationship between market place applications and push clients on one hand, and an update controller on the other in an electronic device according to an example embodiment of the present disclosure.

As shown in FIG. 4, the electronic device may include a plurality of market place applications 416-1 to 416-N, and a plurality of push clients 4121 to 412-N. Since the market place applications and the push client belong to the application stores in general, the plurality of market place applications 416-1 to 416-N and the plurality of push clients 412-1 to 412-N are installed when a plurality of application stores are used. In this embodiment, the update controller 414 adjusts the time to update by controlling update notifications transmitted between the plurality of market place applications 416-1 to 416-N and the plurality of push clients 412-1 to 412-N.

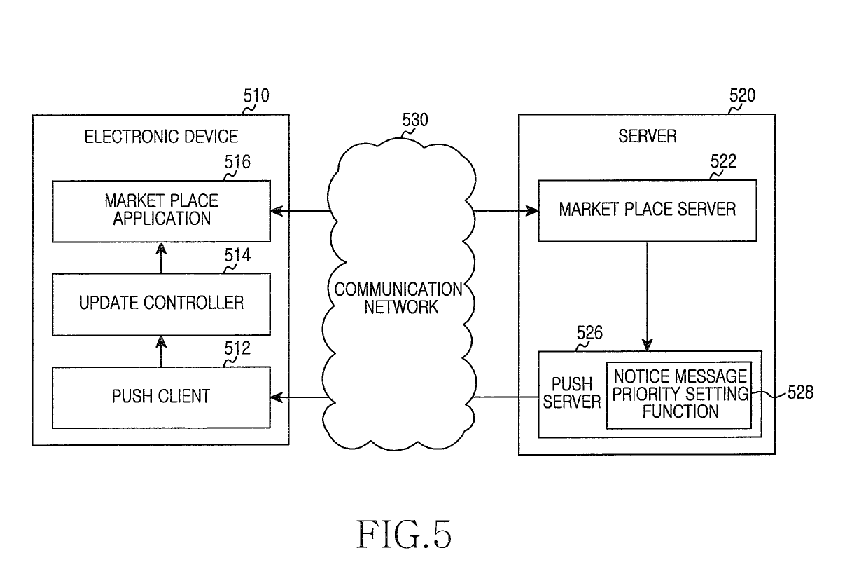

According to another example embodiment of the present disclosure, an update policy based on a priority for the update notification may be added. In this embodiment, the server further includes a function of setting the priority for the update notification. An electronic device and a server according to another example embodiment of the present disclosure are configured as shown in FIG. 5. FIG. 5 illustrates a view showing block configurations of an electronic device and a server which provides an application according to another example embodiment of the present disclosure.

Referring to FIG. 5, the electronic device 510 and the server 520 exchange data with each other through a communication network 530. The communication network 530 may be a 3G network, an LTE network, a Wi-Fi network, and the like. The electronic device 510 includes a push client 512, an update controller 514, and a market place application 516. The server 520 includes a market place server 522 and a push server 526.

The market place server 522 stores and manages applications to be provided to the electronic device 510. In addition, if there is a request for an application, the market place server 522 transmits the requested application to the electronic device through the communication network 530. The push server 526 transmits an update notification for informing of an update to the electronic device 510 where the application registered at the market place server 522 is installed. For example, if an improved version of the application that has been registered at the market place server 522 is newly registered, the push server 526 transmits the update notification to at least one electronic device where the application is installed, through the communication network 530.

Unlike in the example embodiment of FIG. 1, the push server 526 has a notification priority setting function 528. The push server 526 may set a priority for the update notification for informing of the update by means of the notification priority setting function 528, and may include an indicator for informing of the priority. Detailed determination of the priority may vary according to detailed example embodiments. For example, the priority may be determined according to importance of an item to be updated. In an embodiment, if the item to be updated affects whether a function aimed by a corresponding application can be provided or not, the update notification for informing of the corresponding update may be given the highest priority. Alternatively, if the item to be updated has nothing to do with a normal operation of a corresponding application, the update notification for informing of the corresponding update may be given a relatively lower priority.

The push client 512 receives the update notification transmitted from the push server 526. The push client 512 provides the update notification to the update controller 514. However, according to a detailed example embodiment, the push client 512 may recognize the update notification as being transmitted to the market place application 516. That is, the update controller 114 may intercept the update notification which is transmitted from the push client 512 to the market place application 516.

The update controller 514 identifies the update notification output from the push client 512 and intercepts the update notification to prevent it from being transmitted to the market place application 516. That is, the update controller 514 delays transmitting the update notification. If a pre-defined condition is satisfied, the update controller 514 transmits the update notification to the market place application 516. In an embodiment, the update controller 514 controls time to update by controlling the update notification, which is transmitted to the market place application 516 for the application update, based on at least one of a priority of the application, a power state of the electronic device 510, and a connection state of the electronic device.

In an embodiment, unlike in the example embodiment shown in FIG. 1, the update controller 514 controls the time to update by controlling the update notification to be transmitted to the market place application 516 for the application update, based on a priority of a push notification. The priority of the push notification refers to a priority for the update notification determined by the push server 526.

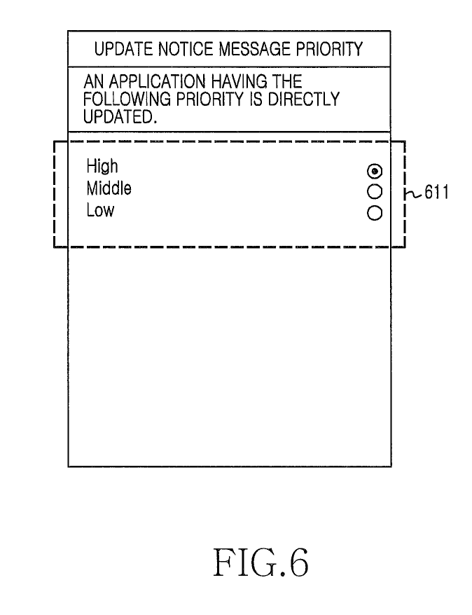

In an embodiment, the update controller 514 may be configured similarly to that of the example embodiment of FIG. 2. In this embodiment, the elements of the update controller 514 may further perform operations based on the priority of the push notification in addition to the functions described with reference to FIG. 2. In an embodiment, the update policy setting UI may further provide a UI for setting the update policy based on the priority of the update notification. For example, as shown in FIG. 6, the UI may include an item 611 for designating the priority of the push notification to allow the update. Through the UI, the user may set whether to perform the update or according to the priority of the update notification. In an embodiment, the user may set to update without determining the other conditions only if a specific priority of the push notification is set. The delay scheduler controls time to transmit the update notification to the market place application based on the priority of the push notification, the priority of the application, the power information, the connection information, and the like.

The market place application 516 receives the update notification and updates the pre-installed application which is identified by the update notification. To achieve this, the market place application 516 requests the improved version of the application from the market place server 522 through the communication network 530, and updates the application by installing the improved version of the application. In this embodiment, according to an example embodiment of the present disclosure, the market place application 516 may update the application swiftly by receiving data for updating the application using multiple connections established through a plurality of communication networks (for example, LTE and Wi-Fi) simultaneously.

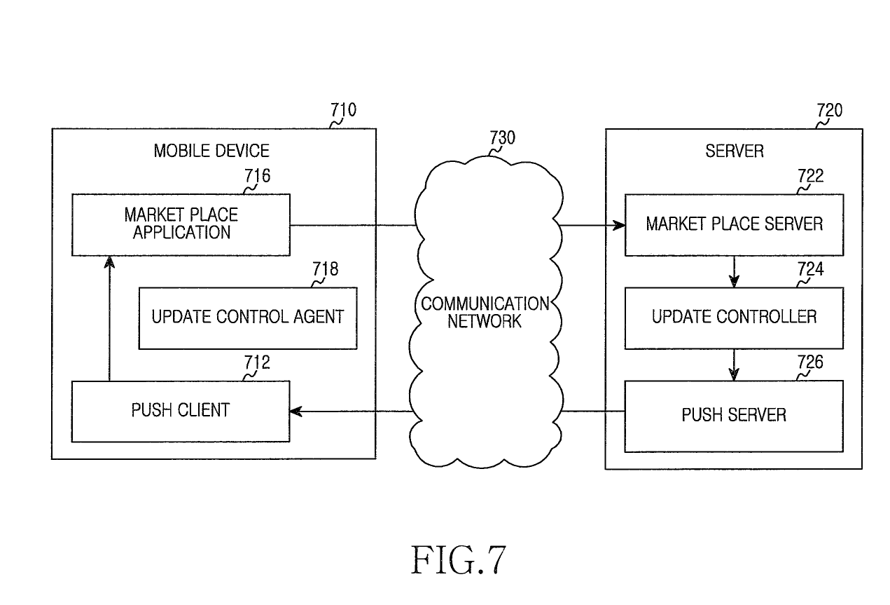

According to another example embodiment of the present disclosure, the update policy function may be included in the server. An electronic device and a server according to another example embodiment are configured as shown in FIG. 7. FIG. 7 illustrates a view showing block configurations of an electronic device and a server which provides an application according to another example embodiment of the present disclosure.

Referring to FIG. 7, the electronic device 710 and the server 720 exchange data with each other through a communication network 730. The communication network 730 may be a 3G network, an LTE network, a Wi-Fi network, and the like. The electronic device 710 includes a push client 712, an update control agent 718, and a market place application 716. The server 720 includes a market place server 722, an update controller 724, and a push server 726.

The market place server 722 stores and manages applications to be provided to the electronic device 710. In addition, if there is a request for an application, the market place server 722 transmits the requested application to the electronic device through the communication network 730.

The update controller 724 controls time to transmit an update notification to the electronic device 710 based on information on the electronic device 710 provided from the update control agent 718. In the embodiment of FIG. 7, the update controller 724 is included in the server 720. However, according to another example embodiment of the present disclosure, the update controller 724 may be implemented in a separate third server and thus may exist in the form of a proxy server.

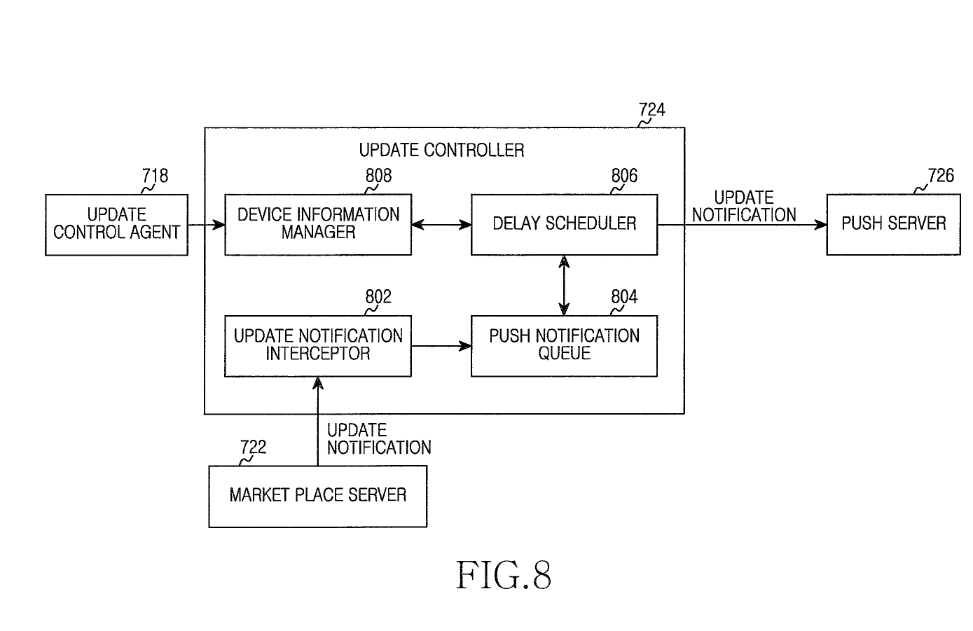

The update controller 724 identifies the update notification output from the market place server 722 and intercepts the update notification to prevent it from being transmitted to the push server 726. That is, the update controller 724 delays transmitting the update notification. If a pre-defined condition is satisfied, the update controller 724 transmits the update notification to the push server 726. In an embodiment, the update controller 724 controls time to update by controlling the update notification, which is transmitted to the push server 726 for the application update, based on at least one of a priority of a push notification, a priority of the application, a power state of the electronic device 710, and a connection state of the electronic device. Hereinafter, the detailed configuration and function of the update controller 724 will be explained with reference to FIG. 8.

The push server 726 transmits the update notification for informing of the update to the electronic device 710 where the application registered at the market place server 722 is installed. For example, if an improved version of the application that has been registered at the market place server 722 is newly registered, the push server 726 transmits the update notification to at least one electronic device where the application is installed, through the communication network 730.

The push client 712 receives the update notification transmitted from the push server 726. The push client 712 provides the update notification to the market place application 716. The market place application 716 receives the update notification and updates the pre-installed application which is identified by the update notification. To achieve this, the market place application 716 requests the improved version of the application from the market place server 722 through the communication network 730, and updates the application by installing the improved version of the application. In this embodiment, according to an example embodiment of the present disclosure, the market place application 716 may update the application swiftly by receiving data for updating the application using multiple connections established through a plurality of communication networks (for example, LTE and Wi-Fi) simultaneously.

The update control agent 718 collects update policy-related information of the electronic device, and provides the update policy-related information to the update controller 724. The update policy-related information includes an update policy and basic infoiination for determining whether a condition based on the update policy is satisfied or not. The update policy is a set of conditions for determining whether to perform the update or not, and the basic information refers to a state of an evaluation target of the condition. For example, the basic information may include at least one of the priority of the push notification, the priority of the application, the power state of the electronic device (for example, a type of power, a battery level), and the connection state of the electronic device (for example, a type of connection, a signal quality). In addition, the update policy defines at least one of a priority range of the application to allow the update, a priority range of the push notification of the application to allow the update, a type of power to allow the update, a battery level to allow the update, a type of connection to allow the update, and a signal quality of connection to allow the update.

FIG. 8 illustrates a view showing a block configuration of an update controller of a server according to another example embodiment of the present disclosure.

Referring to FIG. 8, the update controller 724 includes an update notification interceptor 802, a push notification queue 804, a delay scheduler 806, and a device information manager 808.

The update notification interceptor 802 may receive the update notification output from the market place server 722 on behalf of the push server 726 or may intercept the update notification which is transmitted to the push server 726. In other words, the update notification interceptor 802 intercepts the update notification if the market place server 722 transmits the update notification to the push server 726, and stores the update notification in the push notification queue 804. To this end, the update notification received by the update notification interceptor 802 is not transmitted to the push server 726, which is an original destination. The update notification interceptor 802 may intercept the update notification in the following methods. According to an example embodiment of the present disclosure, the update notification interceptor 802 may hook the update notification in a network layer including an IP. To achieve this, the update notification interceptor 802 could identify the update notification. For example, the update notification interceptor 802 may identify the update notification using a specific bit pattern of an IP packet. According to another example embodiment of the present disclosure, the update notification interceptor 802 may hook the update notification in an OS or an application framework of the electronic device or server. According to another example embodiment of the present disclosure, the update notification interceptor 802 may allow the market place server 722 to explicitly transmit the update notification using a separate API installed in the update controller 724.

The push notification queue 804 temporarily stores the update notification obtained through the update notification interceptor 802. The delay scheduler 806 controls time to transmit the update notification to the push server 726 based on the update policy-related information provided from the device information manager 808. In an embodiment, the delay scheduler 806 determines whether a condition for transmitting the update notification is satisfied or not based on the priority of the push notification, the priority of the application, the power information, the connection information, and the like, and, if the condition is satisfied, transmits the update notification to the push server 726.

The device information manager 808 receives the update policy-related information determined by the electronic device 710 from the update control agent 718. The update policy-related information may be periodically received or may be received if there is a change in the update policy-related information. The update policy-related information includes an update policy and basic information for determining whether a condition based on the update policy is satisfied or not. The update policy is a set of conditions for determining whether to perform the update or not, and the basic information refers to a state of an evaluation target of the condition. For example, the basic information may include at least one of the priority of the push notification, the priority of the application, the power state of the electronic device (for example, a type of power, battery level), and the connection state of the electronic device (for example, a type of connection, a signal quality). In addition, the update policy defines at least one of a priority range of the application to allow the update, a priority range of the push notification of the application to allow the update, a type of power to allow the update, a battery level to allow the update, a type of connection to allow the update, and a signal quality of connection to allow the update.

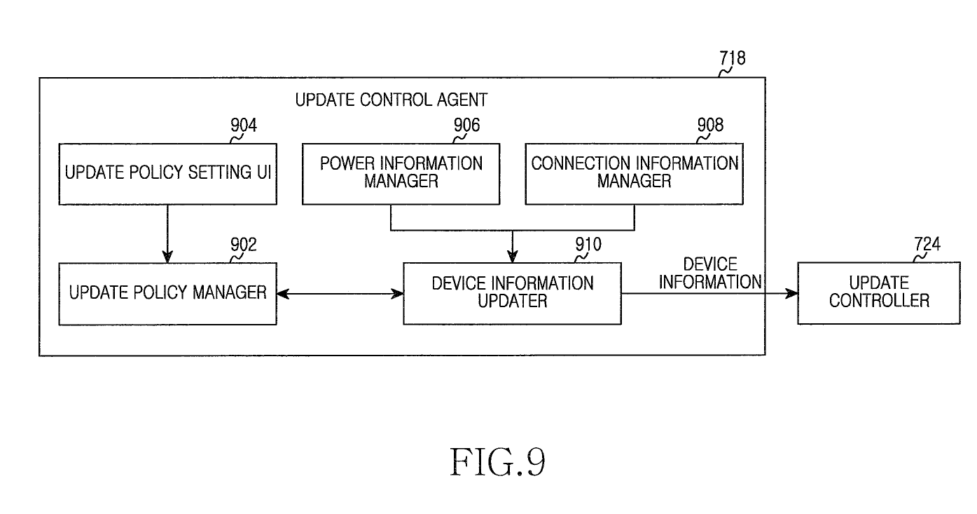

FIG. 9 illustrates a view showing a block configuration of an update control agent of an electronic device according to another example embodiment of the present disclosure.

Referring to FIG. 9, the update control agent 718 includes an update policy manager 902, an update policy setting UI 904, a power information manager 906, a connection information manager 908, and a device information updater 910.

The update policy manager 902 manages update policy-related information which is input through the update policy setting UI 904. The update policy-related information includes an update policy and basic information for determining whether a condition based on the update policy is satisfied or not. The update policy is a set of conditions for determining whether to perform the update or not, and the basic information refers to a state of an evaluation target of the condition. For example, the basic information may include at least one of a priority of a push notification, a priority of an application, a power state of the electronic device (for example, a type of power, a battery level), and a connection state of the electronic device (for example, a type of connection, a signal quality). In addition, the update policy defines at least one of a priority range of the application to allow the update, a priority range of the push notification of the application to allow the update, a type of power to allow the update, a battery level to allow the update, a type of connection to allow the update, and a signal quality of connection to allow the update.

The update policy setting UI 904 provides a UI for the user to set the update policy, and transmits information input by the user to the update policy manager 902. For example, the update policy setting UI 904 may provide a UI for setting the priority of the application as shown in FIG. 3A, a UI for setting the update policy based on the power state as shown in FIG. 3B, a UI for setting the update policy based on the connection state as shown in FIG. 3C, and a UI for setting the update policy based on the priority of the update notification as shown in FIG. 6.

The power information manager 906 collects battery state information of the electronic device and information on whether an AC/USB is connected or not, and provides the information. If the power state of the electronic device is changed, the power information manager 906 informs the device information updater 91 of the change of the power state. The power information includes the battery level, information on whether the AC charging is connected or not, and information on whether the USB is connected or not.

The connection information manager 908 collects information on the connection accessed by the electronic device (for example, Wi-Fi, 3G, LTE, and the like) and provides the information Furthermore, the connection information manager 908 may provide Internet connectivity for each connection or an RSSI. If the connection state of the electronic device is changed, the connection information manager 908 informs the device information updater 910 of the change of the connection state.

The device information updater 910 collects the update policy-related information of the electronic device and provides the update policy-related information to the update controller 724. That is, the device information updater 910 provides information provided from the update policy setting UI 904, the update policy manager 902, the power information manager 906, and the connection information manager 908 to the update controller 724. The update policy-related information may be periodically provided or may be provided if there is a change in the update policy-related information.

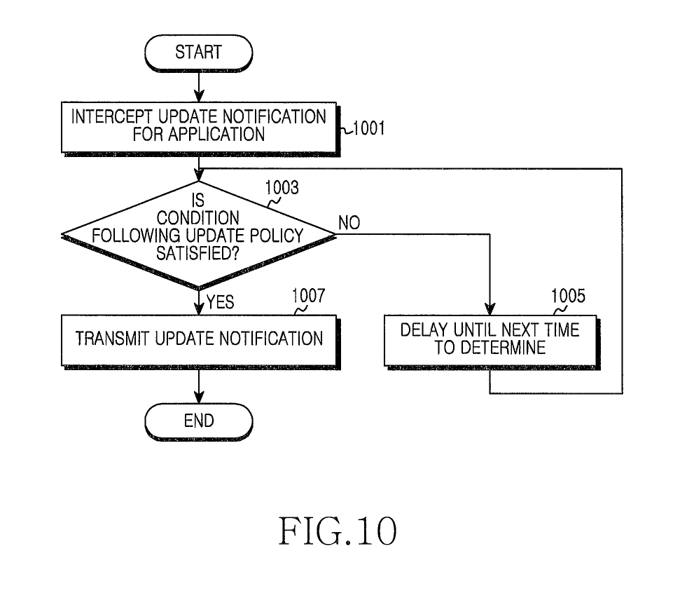

FIG. 10 illustrates a process of an operation procedure of an update controller which is included in an electronic device or a server according to an example embodiment of the present disclosure. The update controller may be a hardware element or a software element. If the update controller is the software element, the procedure of FIG. 10 is performed by a processor for executing the software element. However, hereinafter, a subject that performs the following procedure will be referred to as an “update controller” for convenience of explanation.

Referring to FIG. 10, the update controller intercepts an update notification on an application in operation 1001. That is, the update controller recognizes the update notification transmitted among objects which process an application update-related function, and intercepts the update notification to prevent it from being transmitted. For example, if the update controller is included in the electronic device which is a user device, the update controller intercepts the update notification which is transmitted from a push client to a market place application. For another example, if the update controller is included in the server which provides the application, the update controller intercepts the update notification which is transmitted from a market place server to a push server.

Thereafter, the update controller proceeds to operation 1003 to determine whether a condition based on an update policy is satisfied or not. The update policy is determined based on at least one of regulations provided by the electronic device and setting designated by the user. The update controller determines whether the condition is satisfied or not based on at least one of a priority of a push notification, a priority of an application, and a state of the electronic device. However, if a user instruction to update is input, the update controller determines that the condition is satisfied regardless of the state of the electronic device and the priority. The state of the electronic device may include a type of power, a battery level, a type of connection, a connection signal quality, and the like. The setting designated by the user is obtained through a UI provided by the electronic device. For example, the UI may be represented as shown in FIGS. 3A, 3B, and 3C, and FIG. 6.

If the condition based on the update policy is not satisfied, the update controller proceeds to operation 1005 to stand by until the next time to determine whether the condition is satisfied or not. In other words, the update controller does not transmit the update notification to the market place application or the push server. The time to determine whether the condition is satisfied or not may periodically arrive or may arrive if the state of the electronic device is changed.

Alternatively, if the condition based on the update policy is satisfied, the update controller proceeds to operation 1007 to transmit the update notification. That is, if the update condition is satisfied, the update controller transmits the update notification to the market place application such that the update is performed, or may transmit the update notification to the push server such that the update notification is transmitted to the user device.

Although not shown in FIG. 10, the update controller may further perform an operation of setting the update policy. For example, if the update controller is included in the electronic device which is the user device, the update controller displays Uls for setting the update policy and sets the update policy according to user's input. For another example, if the update controller is included in the server which provides the application, the update controller sets the update policy according to update policy-related information received from the user device. That is, if the update controller is included in the server which provides the application, the update controller may further perform an operation of receiving the update policy-related information from the user device. In this embodiment, the update policy-related information may include not only the update policy but also state information of the electronic device which is a base for determining whether the condition is satisfied or not. In addition, the update policy defines at least one of a priority range of the application to allow the update, a priority range of the push notification of the application to allow the update, a type of power to allows the update, a battery level to allow the update, a type of connection to allow the update, and a signal quality of connection to allow the update.

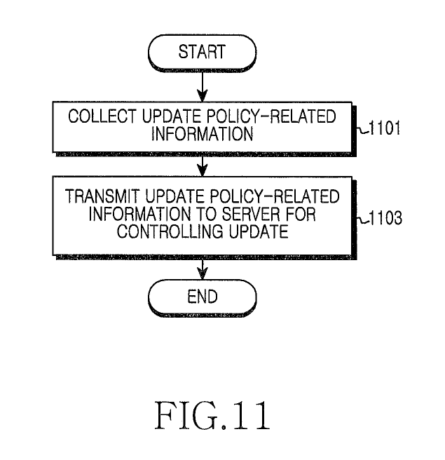

FIG. 11 illustrates a process of an operation procedure of an update control agent included in an electronic device according to an example embodiment of the present disclosure. The update control agent may be a hardware element or a software element. If the update control agent is the software element, the procedure of FIG. 11 is performed by a processor for executing the software element. However, hereinafter, a subject that performs the following procedure will be referred to as an “update control agent” for the convenience of explanation.

Referring to FIG. 11, the update control agent collects update policy-related information in operation 1101. The update policy-related information includes an update policy and basic information for determining whether a condition based on the update policy is satisfied or not. The update policy is a set of conditions for determining whether to perform the update or not, and the basic information refers to a state of an evaluation target of the condition. For example, the basic information may include at least one of a priority of a push notification, a priority of an application, a power state of the electronic device (for example, a type of power, a battery level), and a connection state of the electronic device (for example, a type of connection, a signal quality). In addition, the update policy defines at least one of a priority range of the application to allow the update, a priority range of the push notification of the application to allow the update, a type of power to allow the update, a battery level to allow the update, a type of connection to allow the update, and a signal quality of connection to allow the update. In order to determine the update policy, the update control agent displays Uls for setting the update policy and sets the update policy according to user's input.

Thereafter, the update control agent proceeds to operation 1103 to transmit the update policy-related information to the server which controls the update. That is, the update control agent provides the update policy-related information to the server, such that the server can control time to transmit an update notification according to the update policy. In this embodiment, the update policy-related information may be periodically transmitted or may be transmitted if there is a change in the update policy-related information.

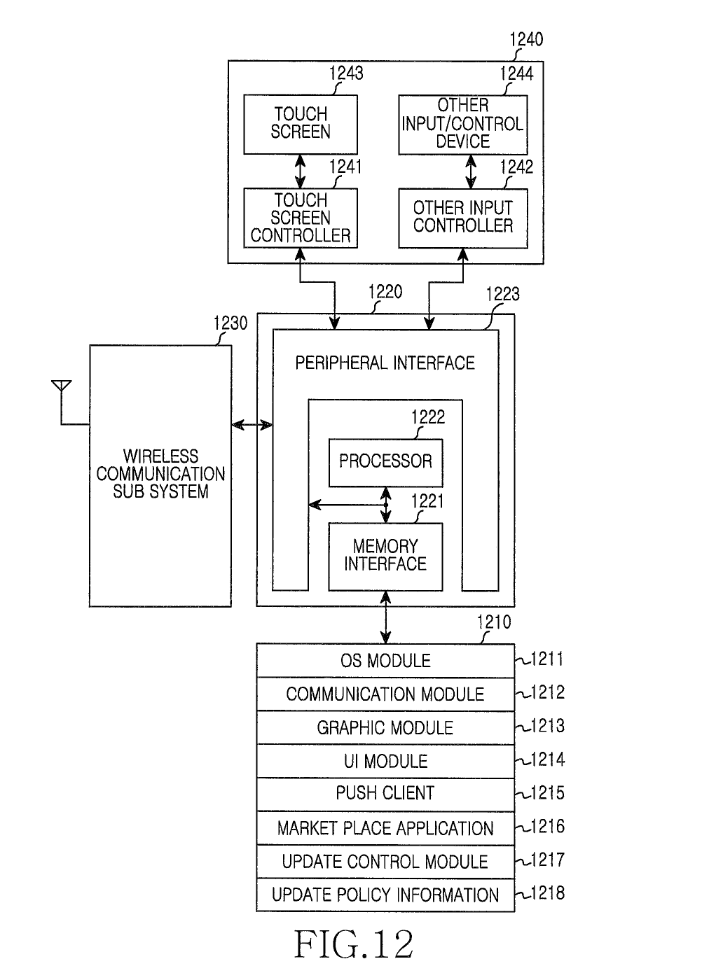

FIG. 12 illustrates a process of a block configuration of an electronic device according to an example embodiment of the present disclosure.

Referring to FIG. 12, the electronic device includes a memory 1210, a processor unit 1220, a wireless communication sub system 1230, and an input output system 1240. The memory 1210 may be comprised of a plurality of memories.

The memory 1210 stores at least one piece of software, a microcode, setting information, and the like. The memory 1210 may include at least one of at least one high speed random access memory, a non-volatile memory, at least one optical storage device, and a flash memory (for example, NAND, NOR). The software element stored in the memory 1210 may include an OS module 1211, a communication module 1212, a graphic module 1213, and a UI module 1214. In addition, the software element stored in the memory 1210 may include a push client 1215, a market place application 1216, and an update control module 1217, and the setting information stored in the memory 1210 may include update policy information 1218. The modules which are the software elements may be represented as a set of instructions and may be referred to as an ‘instruction set’ or a ‘program’.

The OS module 1211 includes at least one software element for controlling a general system operation. For example, the OS module 1211 may be a built-in operating system such as WINDOWS, LINUX, Darwin, RTXC, UNIX, OS X, VxWorks, Android, and iOS. For example, the OS module 1211 is in charge of control of a general system operation, such as memory management and control, storage hardware control and management, power control and management, and the like. The OS module 1211 controls to facilitate communication between at least one hardware element and at least one software element.

The communication module 1212 includes at least one software element for communicating with other electronic devices such as a computer, a server, a portable terminal, and the like through the wireless communication sub system 1230. The graphic module 1213 includes at least one software element for providing and displaying a graphic on a touch screen 1243. The graphic includes a text, a web page, an icon, a digital image, a video, an animation, and the like. The UI module 1214 includes at least one software element for providing a UI. For example, the UI module 1214 controls how the state of the UI is changed or which condition changes the state of the UI.

The push client 1215 includes at least one software element for receiving the update notification transmitted from the push server for informing of the update of the application. The market place application 1216 includes at least one software element for receiving the update notification and updating a pre-installed application which is identified by the update notification. In an embodiment, the market place application 1216 may include at least one software element for requesting an improved version of the application from the market place server 122 through the communication network 130, and installing the improved version of the application.

The update control module 1217 includes at least one software element for setting an update policy and controlling time to update the application according to the update policy. For example, the update control module 1217 includes at least one software element for controlling the electronic device to perform the procedure shown in FIG. 10 or 11. In an embodiment, the update control module 1217 may include at least one software element for intercepting the update notification for informing that it is necessary to update the application, determining whether an update condition based on the update policy is satisfied or not, and, if the update condition is not satisfied, delaying transmitting the update notification until the next time to determine.

The update policy information 1218 includes update policy-related information generated by the update control module 1217. The update policy-related information may be periodically updated or may be updated if there is a change in the update policy-related information. For example, the update policy-related information may include at least one of a push notification priority, an application priority, a power state, a connection state, and user's setting information. The application priority refers to a priority of an application to be updated. For example, an application that is frequently used by the user is given a high priority. For another example, the priority of the application may be directly set by the user. The power state may be divided into information on whether the electronic device uses a battery or not, a battery level if the battery is used, AC charging, and USB charging. The connection state refers to a type of connection accessed by the electronic device (for example, Wi-Fi, 3G, LTE, and the like), or a strength of signal.

The memory 1210 may include an additional module in addition to the above-described modules 1211 to 1218. According to another example embodiment of the present disclosure, some of the above-described modules 1211 to 1218 may be excluded.

The processor unit 1220 includes a memory interface 1221, a processor 1222, and a peripheral interface 1223. The entire processor unit 1220 may be referred to as a ‘processor’ in some embodiments. Each of the memory interface 1221, the processor 1222, and the peripheral interface 1223 may be a separate element or may be included in at least one integrated circuit.

The processor 1222 may include at least one hardware chip. The processor 1222 executes a software module such that the electronic device can perform a function implemented by the software module. In an embodiment, the processor 1222 implements the example embodiments of the present disclosure by interworking with the software modules stored in the memory 1210. The processor 1222 may include at least one data processor and at least one image processor. According to another example embodiment of the present disclosure, the data processor and the image processor may be configured as separate hardware. In addition, the processor 1222 may be comprised of a plurality of processors which perform different functions.

The memory interface 1221 provides a traveling route of data and control signals between the memory 1210 and the processor 1222. For example, the memory interface 1221 provides an interface for accessing the memory 1210. The peripheral interface 1223 connects the input output sub system 1240 of the electronic device and at least one peripheral to the processor 1221 and the memory 1210.

The wireless communication sub system 1230 provides an interface for wireless communication. The wireless communication sub system 1230 may include at least one of a Radio Frequency (RF) receiver/transmitter and a light (for example, infrared rays) receiver/transmitter. The wireless communication sub system 1230 may include communication modems confirming to different standards. The communication modems may be distinguished from one another according to communication networks. For example, although not limited thereto, the communication network may be at least one of a Global System for Mobile communication (GSM) network, an Enhanced Data GSM Environment (EDGE) network, a Code Division Multiple Access (CDMA) network, a Wideband CDMA (W-CDMA) network, an LTE network, an Orthogonal Frequency Division Multiple Access (OFDMA) network, a Wi-Fi network, a WiMax network, and a Bluetooth network. The communication modems may be configured as a single chipset.

The input output sub system 1240 may include a touch screen controller 1241, another input controller 1242, a touch screen 1243, and another input/control device 1244.

The touch screen controller 1241 may be coupled to the touch screen 1243. Although not limited thereto, the touch screen 1243 and the touch screen controller 1241 can use not only capacitance, resistance, infrared and surface sound wave techniques for determining at least one contact point on the touch screen 1243 but also any multi-touch sense technique including other proximity sensor arrays or other elements to detect a contact, a movement, or stopping thereof.

The other input controller 1242 may be coupled to the other input/control device 1244. The other input/control device 1244 may include at least one up/down button for controlling a volume. In addition, the button may have various forms such as a push button or rocker button, a rocker switch, a thumb-wheel, a dial, a stick, and a pointer device such as a stylus.

The touch screen 1243 provides an input/output interface between the electronic device and the user. For example, the touch screen 1243 delivers touch input of the user to the electronic device. In addition, the touch screen 1243 is a means for showing output from the electronic device to the user. For example, the touch screen 1243 shows visual output to the user. Such visual output is represented in the faith of a text, a graphic, a video, and a combination thereof. For example, the touch screen 1243 may display the UI screen as shown in FIGS. 3A, 3B, and 3C and FIG. 6. A variety of displays can be used as the touch screen 1243. For example, although not limited thereto, the touch screen 1243 may include at least one of a Liquid Crystal Display (LCD), a Light Emitting Diode (LED), a Light Emitting Polymer Display (LPD), an Organic Light Emitting Diode (OLED), an Active Matrix Organic Light Emitting Diode (AMOLED), and a Flexible LED (FLED).

In the example embodiment shown in FIG. 12, the update control function is implemented as a software element. However, according to another example embodiment of the present disclosure, the update control function may be implemented as a hardware element. In this embodiment, the function of the update control module 1217 may be implemented as at least one processor in the processor unit 1220.

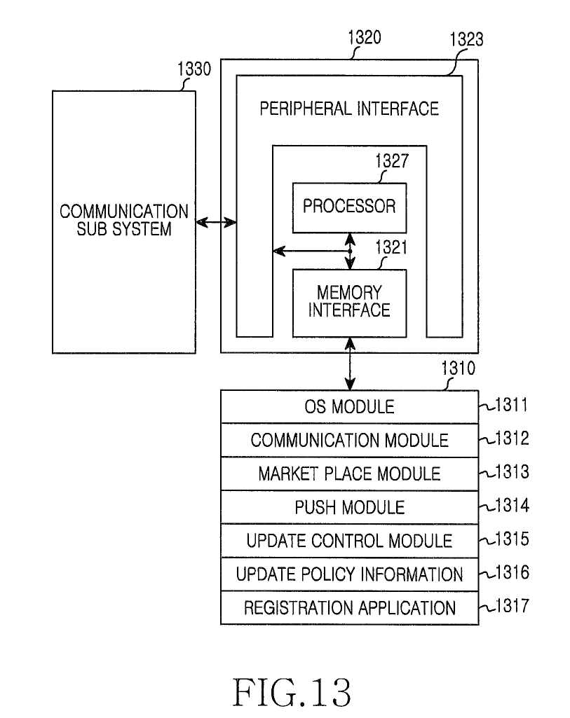

FIG. 13 illustrates a process of a block configuration of a server according to an example embodiment of the present disclosure.

The server includes a memory 1310, a processor unit 1320, and a communication sub system 1330. The memory may be comprised of a plurality of memories.

The memory 1310 stores at least one piece of software, a microcode, setting information, and the like. The memory 1310 may include at least one of at least one high speed random access memory, a non-volatile memory, at least one optical storage device, and a flash memory (for example, NAND, NOR). The software element stored in the memory 1310 may include an OS module 1311 and a communication module 1312. In addition, the software element stored in the memory 1310 may include a market place module 1313, a push module 1314, and an update control module 1315. The setting information stored in the memory 1310 may include update policy information 1318. In addition, the memory 1310 may store a registration application 1317. The registration application 1317 is an application to be provided to the user device and may be stored in the form of an installation file. The modules which are the software elements may be represented as a set of instructions and may be referred to as an ‘instruction set’ or a ‘program’.

The OS module 1311 includes at least one software element for controlling a general system operation. For example, the OS module 1311 may be a built-in operating system such as WINDOWS, LINUX, Darwin, RTXC, UNIX, OS X, VxWorks, Android, and iOS. For example, the OS module 1311 is in charge of control of a general system operation, such as memory management and control, storage hardware control and management, power control and management, and the like. The OS module 1311 controls to facilitate communication between at least one hardware element and at least one software element. The communication module 1312 includes at least one software element for communicating with other servers such as a computer, a server, a portable terminal, and the like through the communication sub system 1330.

The market place module 1313 includes at least one software element for storing and managing applications to be provided to the user device. In an embodiment, the market place module 1313 may include at least one software element for transmitting a requested application to the user device through the communication sub system 1330 if there is a request for the application from the user device.

The push module 1314 includes at least one software element for transmitting an update notification for informing of the update to the user device where an application registered at the server (for example, a registration application 1317) is installed. For example, the push module 1314 may include at least one software element for transmitting the update notification to at least one user device where the application is installed through the communication sub system 1330 if an improved version of the application registered at the server is newly registered.

The update control module 1315 includes at least one software element for setting an update policy and controlling time to update the application according to the update policy. For example, the update control module 1315 includes at least one software element for controlling the server to perform the procedure shown in FIG. 10. In an embodiment, the update control module 1315 may include at least one software element for intercepting the update notification for informing that it is necessary to update the application, determining whether an update condition based on the update policy is satisfied or not, and, if the update condition is not satisfied, delaying transmitting the update notification until the next time to determine.

The update policy information 1318 includes update policy-related information received by the update control module 1315. The update policy-related information may be periodically updated or may be updated if there is a change in the update policy-related information. For example, the update policy-related information may include at least one of a push notification priority, an application priority, a power state, a connection state, and user's setting information. The application priority refers to a priority of an application to be updated. For example, an application that is frequently used by the user is given a high priority. For another example, the priority of the application may be directly set by the user. The power state may be divided into information on whether the electronic device uses a battery or not, a battery level if the battery is used, AC charging, and USB charging. The connection state refers to a type of connection accessed by the electronic device (for example, Wi-Fi, 3G, LTE, and the like), or a strength of signal.

The memory 1310 may include an additional module in addition to the above-described modules 1311 to 1317. According to another example embodiment of the present disclosure, some of the above-described modules 1311 to 1318 may be excluded.

The processor unit 1320 includes a memory interface 1321, a processor 1322, and a peripheral interface 1323. The entire processor unit 1320 may be referred to as a ‘processor’ in some embodiments. Each of the memory interface 1321, the processor 1322, and the peripheral interface 1323 may be a separate element or may be included in at least one integrated circuit.

The processor 1322 may include at least one hardware chip. The processor 1322 executes a software module such that the server can perform a function implemented by the software module. In an embodiment, the processor 1322 implements the example embodiments of the present disclosure by interworking with the software modules stored in the memory 1310. The processor 1322 may include at least one data processor and at least one image processor. According to another example embodiment of the present disclosure, the data processor and the image processor may be configured as separate hardware. In addition, the processor 1322 may be comprised of a plurality of processors which perform different functions.

The memory interface 1321 provides a traveling route of data and control signals between the memory 1310 and the processor 1322. For example, the memory interface 1321 provides an interface for accessing the memory 1310. The peripheral interface 1323 connects at least one peripheral of the server to the processor 1321 and the memory 1310.

The communication sub system 1330 provides an interface for communication. That is, the communication sub system 1330 performs conversion between transmission and reception bit strings and physical transmission signals.

In the example embodiment shown in FIG. 13, the update control function is implemented as a software element. However, according to another example embodiment of the present disclosure, the update control function may be implemented as a hardware element. In this embodiment, the function of the update control module 1315 may be implemented as at least one processor in the processor unit 1320.

The application update control method described above according to the example embodiments of the present disclosure is applicable not only to the application update in the market place application but also to push-based communication between the electronic device and the server. That is, the present disclosure may be applied to an update related to applications in push-based communication or all kinds of updates requiring synchronization with the server.

When the application installed in the electronic device is updated, the whole system on a platform, an OS, or middleware of the electronic device controls the function for the application update such that the application update can be effectively controlled. Accordingly, the battery life of the electronic device can be extended. Furthermore, the update is provided according to the priority of the update and the priority of the application, such that the application can be updated considering the user experience (UX) and the battery life.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

In the above-described example embodiments of the present disclosure, the elements included in the disclosure are expressed in a singular or plural form according to a detailed example embodiment. However, the singular or plural expression is appropriately selected according to a proposed situation for the convenience of explanation and the disclosure is not limited to a single element or a plurality of elements. The elements expressed in the plural form may be configured as a single element and the elements expressed in the singular form may be configured as a plurality of elements.

What is claimed is:

1. A method for updating an application installed in an electronic device, the method comprising:
intercepting an update notification for informing that it is necessary to update the application;
determining whether an update condition based on an update policy is satisfied or not; and
if the update condition is not satisfied, delaying transmitting the update notification until a next time to determine.

2. The method of claim 1, wherein the update policy defines at least one of a priority range of an application to allow an update, a priority range of a push notification of an application to allow an update, a type of power to allow an update, a battery level to allow an update, a type of connection to allow an update, and a signal quality of connection to allow an update.

3. The method of claim 1, wherein the determining whether the update condition is satisfied or not comprises collecting basic information for determining whether the update condition is satisfied or not, and
wherein the basic information comprises at least one of a priority of a push notification, a priority of an application, a type of power of the electronic device, a battery level of the electronic device, a type of connection of the electronic device, and a signal quality of the electronic device.

4. The method of claim 3, wherein the determining whether update condition is satisfied or not further comprises receiving the basic information from the electronic device.

5. The method of claim 1, further comprising:
if the update condition is satisfied, transmitting the update notification to an application which updates the application.

6. The method of claim 5, further comprising:
if the update condition is satisfied, receiving data for the update through multiple connections established through different communication networks.

7. The method of claim 1, further comprising:
if the update condition is satisfied, transmitting the update notification to a push server which transmits the update notification to the electronic device.

8. The method of claim 1, further comprising:
setting the update policy.

9. The method of claim 8, wherein the setting the update policy comprises:
displaying a UI for setting the update policy; and
setting the update policy according to information input through the UI.

10. The method of claim 9, wherein the UI for setting the update policy comprises at least one of an item for selecting whether a priority of an application is automatically set or not, an item for directly setting whether to update or not according to a priority of an application, an item for designating a priority of an application, an item for designating a type of power to allow an update, an item for designating a battery level to allow an update, an item for designating a battery level to prohibit an update, an item for designating a type of connection to allow an update, an item for designating a signal quality to allow an update, and an item for designating a priority of a push notification to allow an update.

11. The method of claim 8, wherein the setting the update policy further comprises receiving the update policy from the electronic device.

12. The method of claim 1, further comprising:
displaying a UI for informing of existence of the intercepted update notification;
if a user determines to proceed with the update, transmitting the update notification regardless of the update policy.

13. The method of claim 1, wherein the update notification comprises an indicator for indicating a priority of a push notification.

14. The method of claim 1, wherein the intercepting the update notification comprises hooking the update notification in a network layer comprising an IP.

15. The method of claim 1, wherein the intercepting the update notification comprises hooking the update notification in one of an OS and an application framework of the electronic device or server.

16. The method of claim 1, wherein the intercepting the update notification comprises receiving the update notification using an API for intercepting the update notification.

17. An apparatus for updating an application installed in an electronic device, the apparatus comprising:
a memory configured to store an update policy for controlling a time to update the application; and
a processor configured to intercept an update notification for informing that it is necessary to update the application, determine whether an update condition based on the update policy is satisfied or not; and, if the update condition is not satisfied, delay transmitting the update notification until a next time to determine.

18. The apparatus of claim 17, wherein the update policy defines at least one of a priority range of an application to allow an update, a priority range of a push notification of an application to allow an update, a type of power to allow an update, a battery level to allow an update, a type of connection to allow an update, and a signal quality of connection to allow an update.

19. The apparatus of claim 17, wherein the processor is configured to collect basic information for determining whether the update condition is satisfied or not, and
wherein the basic information comprises at least one of a priority of a push notification, a priority of an application, a type of power of the electronic device, a battery level of the electronic device, a type of connection of the electronic device, and a signal quality of the electronic device.

20. The apparatus of claim 19, further comprising:
a communicator configured to receive the basic information from the electronic device.

21. The apparatus of claim 17, wherein, if the update condition is satisfied, the processor is configured to control a communicator to transmit the update notification to an application which updates the application.

22. The apparatus of claim 21, wherein, if the update condition is satisfied, the processor is configured to control the communicator to receive data for the update through multiple connections established through different communication networks.

23. The apparatus of claim 17, wherein, if the update condition is satisfied, the processor is configured to control a communicator to transmit the update notification to a push server which transmits the update notification to the electronic device.

24. The apparatus of claim 17, wherein the processor is configured to set the update policy.

25. The apparatus of claim 24, wherein the processor is configured to control a display to display a UI for setting the update policy, and sets the update policy according to information input through the UI.

26. The apparatus of claim 25, wherein the UI for setting the update policy comprises at least one of an item for selecting whether a priority of an application is automatically set or not, an item for directly setting whether to update or not according to a priority of an application, an item for designating a priority of an application, an item for designating a type of power to allow an update, an item for designating a battery level to allow an update, an item for designating a battery level to prohibit an update, an item for designating a type of connection to allow an update, an item for designating a signal quality to allow an update, and an item for designating a priority of a push notification to allow an update.

27. The apparatus of claim 25, further comprising:
a communicator configured to receive the update policy from the electronic device.

28. The apparatus of claim 17, wherein the processor is configured to control a display to display a UI for informing of existence of the intercepted update notification, and, if a user determines to proceed with the update, transmits the update notification regardless of the update policy.

29. The apparatus of claim 17, wherein the update notification comprises an indicator for indicating a priority of a push notification.

30. The apparatus of claim 17, wherein the processor is configured to hook the update notification in a network layer comprising an IP in order to intercept the update notification.

31. The apparatus of claim 17, wherein the processor is configured to hook the update notification in one of an OS and an application framework of the electronic device or server in order to intercept the update notification.

32. The apparatus of claim 17, wherein the processor is configured to receive the update notification using an API for intercepting the update notification in order to intercept the notification.

33. An electronic apparatus comprising:
a memory configured to store at least one software module; and
a processor configured to execute the at least one software module stored in the memory,
wherein the at least one software module intercepts an update notification for informing that it is necessary to update the application, determines whether an update condition based on an update policy is satisfied or not; and, if the update condition is not satisfied, delays transmitting the update notification until a next time to determine.
